(19) United States
(12) Patent Application Publication
(10) Pub. No.: US 2018/0018495 A1
(43) Pub. Date: Jan. 18, 2018

(54) FINGERPRINT IDENTIFICATION MODULE AND FINGERPRINT IDENTIFICATION METHOD

(71) Applicant: Gingy Technology Inc., Hsinchu City (TW)

(72) Inventors: Chun-Lang Hung, Hsinchu City (TW); Tsung-Shan Chen, Hsinchu City (TW)

(73) Assignee: Gingy Technology Inc., Hsinchu City (TW)

(21) Appl. No.: 15/455,097

(22) Filed: Mar. 9, 2017

Related U.S. Application Data
(60) Provisional application No. 62/363,329, filed on Jul. 17, 2016.

(30) Foreign Application Priority Data
Jan. 20, 2017 (TW) 106102048

(51) Int. Cl. G06K 9/00; G06K 9/46

(52) U.S. Cl. CPC G06K 9/0004; G06K 9/4652; G06K 9/00087; G06K 9/00114

(57) ABSTRACT

A fingerprint identification module including an imaging unit, a light emitting element, an optical receiver, and a processing unit is provided. The imaging unit is configured to generate a first image light beam according to whether a loop is formed when an object contacts the imaging unit. The light emitting element is configured to emit a scanning beam to the object, so that the object reflects a second image light beam. The optical receiver is configured to generate a first object image and a second object image respectively according to the first image light beam and the second image light beam. The processing unit is configured to judge whether the second object image has a color change to determine the object is a living body. A fingerprint identification method is also provided.

### CROSS-REFERENCE TO RELATED APPLICATION

This application claims the priority benefits of U.S. provisional application Ser. No. 62/363,329, filed on Jul. 17, 2016, and Taiwan application serial no. 106102048, filed on Jan. 20, 2017. The entirety of each of the above-mentioned patent applications is hereby incorporated by reference herein and made a part of this specification.

### FIELD OF THE INVENTION

The invention relates to an identification technology. More particularly, the invention relates to a fingerprint identification module and a fingerprint identification method to identify whether a finger is a living body.

### DESCRIPTION OF RELATED ART

Types of biometric identification include face, voice, iris, retina, vein, and fingerprint identifications. Every individual has a unique fingerprint. Moreover, changes of an individual's age or health condition do not easily change the fingerprint. Therefore, the fingerprint identification module has become one of the most popular biometric identification systems nowadays. The fingerprint identification module may further be categorized into optical, capacitive, ultrasonic, and thermal sensing identification modules according to different sensing methods.

However, conventional fingerprint identification modules are unable to effectively identify differences between a real fingerprint and a fake fingerprint (of a living body or a non-living body). As a result, criminals tend to fabricate fake fingers usually with silicon gel, and the fake fingerprints and ports are also fabricated on the fake fingers. When a fake finger made of the silicon gel and having the fake fingerprints and pores is pressed on a conventional fingerprint identification module, the fake finger showing the characteristics of fingerprints, pores, and finger deformation caused by the pressing action may deceive the conventional fingerprint identification module. Furthermore, the conventional fingerprint identification module is unable to correctly identify whether the pressing action is performed by a finger of a living body, leading to a loophole in identification as a result. Therefore, solutions are provided in the following embodiments of the invention.

### SUMMARY OF THE INVENTION

The invention provides a fingerprint identification module and a fingerprint identification method to effectively identify whether an object pressed on the fingerprint identification module is a finger of a living body through a two-phase identification mechanism. Furthermore, whether an image obtained is a real fingerprint image may be effectively judged, so as to perform a fingerprint identification on the real fingerprint image.

In an embodiment of the invention, a fingerprint identification module includes an imaging unit, a light emitting element, an optical receiver, and a processing unit. The imaging unit is configured to generate a first image light beam according to whether a loop is formed when an object contacts the imaging unit. The light emitting element is configured to emit a scanning beam to the object, so that the object reflects a second image light beam. The optical receiver is configured to receive the first image light beam and the second image light beam and generate a first object image and a second object image respectively according to the first image light beam and the second image light beam. The processing unit is electrically connected to the optical receiver. The processing unit is configured to receive the first object image and the second object image. The processing unit judges whether the second object image has a color change to determine the object is a living body.

In an embodiment of the invention, a fingerprint identification method is suitable for a fingerprint identification module. The fingerprint identification module includes an imaging unit, a light emitting element, an optical receiver, and a processing unit. The fingerprint identification method includes following steps. A first image light beam is generated according to whether a loop is formed when an object contacts the imaging unit. A scanning beam is emitted to the object, such that the object reflects a second image light beam. The first image light beam and the second image light beam are received, and a first object image and a second object image are generated respectively according to the first image light beam and the second image light beam. Whether the second object image has a color change is judged to determine the object is a living body.

In view of the foregoing, the fingerprint identification module and the fingerprint identification method provided by the embodiments of the invention may perform a two-phase identification function. First, whether an electric field distribution may be generated when the object contacts the imaging unit is judged by the fingerprint identification module to determine the object is a living body. Next, whether the object image provided by the optical receiver has the color change is judged by the fingerprint identification module to determine the object is a living body. As such, the fingerprint identification module and the fingerprint identification method provided by the embodiments of the invention may be applied to effectively identify a real finger or a fake finger.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view illustrating a fingerprint identification module according to an embodiment of the invention.

FIG. 2 is a schematic enlarged view illustrating a portion of a fingerprint identification module according to an embodiment of the invention.

FIG. 3 is a flowchart illustrating steps of a fingerprint identification method according to an embodiment of the invention.

FIG. 4 is a schematic view illustrating a first chromaticity coordinate axis of a real fingerprint according to an embodiment of the invention.

FIG. 5 is a schematic view illustrating a first chromaticity coordinate axis of a fake fingerprint according to an embodiment of the invention.

FIG. 6 is a schematic view illustrating a second chromaticity coordinate axis of a real fingerprint according to an embodiment of the invention.

FIG. 7 is a schematic view illustrating a second chromaticity coordinate axis of a fake fingerprint according to an embodiment of the invention.

### DESCRIPTION OF THE EMBODIMENTS

The term “coupled to” used throughout the embodiments (including claims) may refer to any direct and indirect connection means. For example, if a first device is described as being coupled to a second device in the embodiments, the sentence should be explained as the first device may be connected to the second device directly, or the first device may, through any other device or through certain connection means, be connected to the second device indirectly. Moreover, elements/components/steps with the same reference numerals represent the same or similar parts in the drawings and embodiments. Elements/components/steps with the same reference numerals used in different embodiments can be incorporated herein by reference.

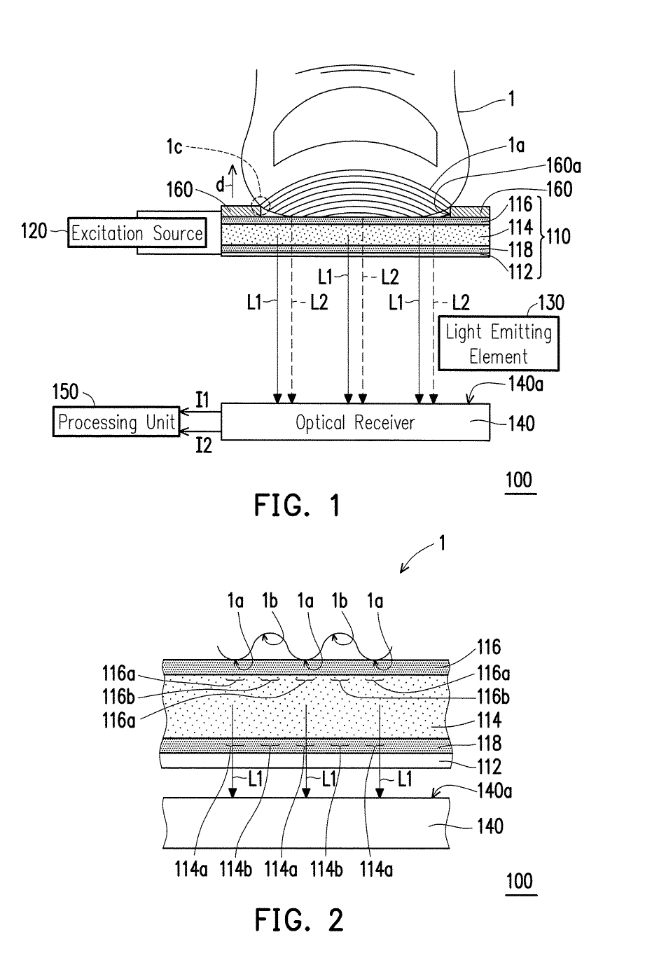

FIG. 1 is a schematic view illustrating a fingerprint identification module according to an embodiment of the invention. Referring to FIG. 1, a fingerprint identification module 100 includes an imaging unit 110, an excitation source 120, a light emitting element 130, an optical receiver 140, and a processing unit 150. The processing unit 150 is electrically connected to the optical receiver 140. In the embodiment, the imaging unit 110 correspondingly generates a first image light beam L1 according to whether a loop is correspondingly formed at a contact position between the imaging unit 110 and an object 1. The loop may be, for example, an electrical loop, a magnetic field loop, etc. Besides, in the embodiment, the light emitting element 130 is configured to emit a scanning beam to the object 1, so that the object 1 correspondingly reflects a second image light beam L2 to the optical receiver 140. The optical receiver 140 is configured to receive the first image light beam L1 and the second image light beam L2 and generate a second object image I2 of the object 1 according to the second image light beam L2. In the embodiment, the processing unit 150 is configured to receive a first object image I1 and the second object image I2 and analyze whether the second object image I2 has a specific color change, so as to determine the object 1 is a living body (a real finger) and further determine at least one of the first object image I1 and the second object image I2 is a real fingerprint image. The processing unit 150 may perform a fingerprint identification on the real fingerprint image. In the embodiment, the real fingerprint image refers to a finger image obtained from the living body and has a fingerprint feature. It is worth noting that the fingerprint identification provided by the embodiments of the invention is not limited to be applied to a finger. The object 1 may also be a palm. The fingerprint identification module 100 may be used to identify whether the object 1 is a real palm, so as to further determine at least one of the first object image I1 and the second object image I2 is obtained from the living body and is a palm image with a palm print feature. Nevertheless, the finger is exemplified in the following embodiments.

In the embodiment, the imaging unit 110 may be formed on a transparent substrate. The transparent substrate may be a microstructure layer formed by a plurality of microstructures disposed continuously or discontinuously on a surface away from a first dielectric layer 116. The microstructures may be shaped respectively as an ellipse, a triangle, etc., and the invention is not limited thereto. In an embodiment, the imaging unit 110 may also be formed on other suitable components, which should not be construed as a limitation to the invention.

In the embodiment, the fingerprint identification module 100 has a two-phase anti-counterfeiting mechanism to determine whether the object 1 is a living body and to further determine at least one of the first object image I1 and the second object image I2 is a real fingerprint image, such that the processing unit 150 may authenticate the identity through the fingerprint feature according to at least one of the first object image I1 and the second object image I2. Nevertheless, people having ordinary skill in the art may acquire sufficient teachings, suggestions, and other details related to the identification operation on the fingerprint feature are not further provided hereinafter.

Imaging mechanisms of the first object image I1 and the second object image I2 are further described as follows. FIG. 2 is a schematic enlarged view illustrating a portion of a fingerprint identification module according to an embodiment of the invention. Referring to FIG. 1 and FIG. 2. In the embodiment, the imaging unit 110 includes an electrode 112, a light emitting layer 114 disposed on the electrode 112, and the first dielectric layer 116 disposed on the light emitting layer 114. The electrode 112 is a transparent electrode. In the embodiment, the imaging unit 110 may further include a second dielectric layer 118. The second dielectric layer 118 is located between the light emitting layer 114 and the electrode 112. The electrode 112, the second dielectric layer 118, the light emitting layer 114, and the first dielectric layer 116 are arranged sequentially along a direction d pointing at the object 1. The light emitting layer 114 emits light if the light emitting layer 114 is affected by the corresponding excitation source 120. A material of the light emitting layer 114 may be an inorganic material, an organic material, or a combination thereof. Besides, in an embodiment, a protection layer (not shown) may be formed on the first dielectric layer 116 away from the second dielectric layer 118 and is configured to protect the first dielectric layer 116. In the embodiment, the light emitting layer 114 is, for example, an electroluminescence (EL) layer. Nevertheless, the invention is not limited thereto.

In the embodiment, the excitation source 120 is, for example, a power source. The power source may output a direct current, an alternating current, or a combination thereof. The excitation source 120 is configured to output energy to the electrode 112 of the imaging unit 110 and the object 1. When at least one portion 1a of the object 1 contacts a portion 116a of the dielectric layer 116, the energy outputted by the excitation source 120 may act on a portion 114a of the light emitting layer 114 corresponding to the portion 116a of the first dielectric layer 116, such that the portion 114a of the light emitting layer 114 emits the first image light beam L1. In the embodiment, the portion 116a of the first dielectric layer 116 and the portion 114a of the light emitting layer 114 may overlap in the direction d. Nevertheless, the invention is not limited thereto. More specifically, at least one portion 1a of the object 1 is, for example, a ridge of a fingerprint. When the at least one portion 1a of the object 1 (e.g., the ridge of the fingerprint) contacts the portion 116a of the first dielectric layer 116, a loop is formed between the portion 116a of the first dielectric layer 116 and the electrode 112, such that the portion 114a of the light emitting layer 114 corresponding to the portion 116a of the first dielectric layer 116 emits the first image light beam L1. When the at least one portion 1a of the object 1 (e.g., the ridge of the fingerprint) contacts the first dielectric layer 116, another portion 1b of the object 1 (e.g., a valley of the fingerprint) does not contact the first dielectric layer 116; as a result, no loop is formed between another portion 116b of the first dielectric layer 116 corresponding to the portion 1b of the object 1 (e.g., the valley of the fingerprint) and the electrode 112, and another portion 114b of the light emitting layer 114 does not emit light. Thereby, the first image light beam L1 emitted by the light emitting layer 114 is able to reflect the at least one portion 1a of the object 1 (the ridge of the fingerprint), and the optical receiver 140 further receives an image of the at least one portion 1a of the object 1 with a high contrast.

In the embodiment, a conductive element 160 is disposed on the first dielectric layer 116 of the imaging unit 110 and has an opening 160a exposing the first dielectric layer 116. In other words, in the embodiment, the conductive element 160 may be shaped as a frame, but the invention is not limited thereto. In another embodiment, the conductive element 160 may also have other suitable shapes. In the embodiment, the conductive element 160 may be selectively disposed above the first dielectric layer 116. Nevertheless, the invention is not limited thereto. In another embodiment, the conductive element 160 may also be integrated in the first dielectric layer 116. The conductive element 160 and the first dielectric layer 116 may contact the same surface of the light emitting layer 114, such that an overall thickness of an image-retrieving apparatus 100 (not shown) may be reduced.

In the embodiment, the conductive element 160 and the first dielectric layer 116 are electrically connected. The excitation source 120 is electrically connected to the conductive element 160 and the electrode 112 of the imaging unit 110. Hence, when the at least one portion 1a of the object 1 contacts the portion 116a of the first dielectric layer 116, another portion 1c of the object 1 contacts the conductive element 160 at the same time. Here, the excitation source 120 may transmit the energy (e.g., an electric energy) to the at least one portion 1a of the object 1 contacting the first dielectric layer 116 through the conductive element 160, such that the portion 114a of the light emitting layer 114 corresponding to the at least one portion 1a of the object 1 emits the first image light beam L1, and image information of the at least one portion 1a of the object 1 is further obtained.

In the embodiment, types of energy outputted by the excitation source 120 and methods to transmit the energy to the object 1 may be plural. The types of energy outputted by the excitation source 120 are not limited to the electric energy; for example, the magnetic energy may also be outputted by the excitation source 120. Since the excitation source 120 may be further connected to an energy conversion unit, the magnetic energy may be converted into the electric energy, and then the electric energy is converted into a light energy through the energy conversion unit. Alternatively, other types of energy (e.g., a kinetic energy) may also be converted into the electric energy first and then be converted into the light energy through such an energy conversion unit. The methods to transmit the electric energy to the object 1 are not limited to the method of transmitting energy through the conductive element 160. In another embodiment, other suitable designs may also be provided according to actual requirements for the types of energy outputted by the excitation source 120 and the methods to transmit the energy to the object 1.

In the embodiment, the light emitting element 130 may be, for example, a light emitting diode (LED), such that a surface of the object 1 may reflect the second image light beam L2 to the optical receiver 140 according to the scanning beam. The light emitting element 130 may be configured to emit a single-wavelength or multiple-wavelength scanning beam to the object 1. If the single-wavelength scanning beam is emitted, the optical receiver 140 may further receive a gray-scale object image through the second image light beam L2 reflected by the object 1. If the multiple-wavelength scanning beam is emitted, the optical receiver 140 may receive a multi-color object image. In addition, the light emitting element 130 may be a light source or a plurality of light sources and be packaged in the optical receiver 140 or independently disposed around or above the optical receiver 140. The invention is not limited thereto.

In the embodiment, the optical receiver 140 may be an optical receiver with a two-dimensional sensing array, for example, a charge-coupled device (CCD), a complementary metal oxide semiconductor (CMOS), etc., but the invention is not limited thereto.

In the embodiment, the optical receiver 140 is disposed on a transmission path of the first image light beam L1 and the second image light beam L2. In the embodiment, the first image light beam L1 and the second image light beam L2 may be imaged on an optical receiving surface 140a of the optical receiver 140. After the optical receiving surface 140a of the optical receiver 140 receives the first image light beam L1 and the second image light beam L2, the optical receiver 140 converts the first image light beam L1 and the second image light beam L2 into image information of the first object image I1 and the second object image I2 corresponding to the at least one portion 1a of the object 1. The image information is an electric signal. In the embodiment, in order to determine whether the object 1 is a living body, the processing unit 150 may perform a color analysis on the second object image I2 to judge whether the second object image I2 has a specific color change and to further determine at least one of the first object image I1 and the second object image I2 is a real fingerprint image.

In other words, in the first-phase anti-counterfeiting mechanism of the fingerprint identification module 100 provided by the embodiment, the imaging unit 110 generates the first image light beam L1 according to whether the loop is formed at the contact position between the imaging unit 110 and the object 1. In the second-phase anti-counterfeiting mechanism of the fingerprint identification module 100, the processing unit 150 analyzes whether the second image light beam L2 has a special color change to determine the object 1 is a living body.

In addition, the processing unit 150 provided by the embodiment may include a single-core or multi-core central processing unit (CPU), a programmable microprocessor for general use or special use, a digital signal processor (DSP), a programmable controller, an application specific integrated circuit (ASIC), a programmable logic device (PLD), other similar devices, or a combination of these devices to perform the fingerprint identification method provided by the embodiments of the invention. Moreover, the processing unit 150 may be connected externally to or may include a memory device. The memory device is, for example, a random access memory (RAM), a read-only memory (ROM), a flash memory, etc. The memory device is at least configured to store the various image data described in the embodiments of the invention.

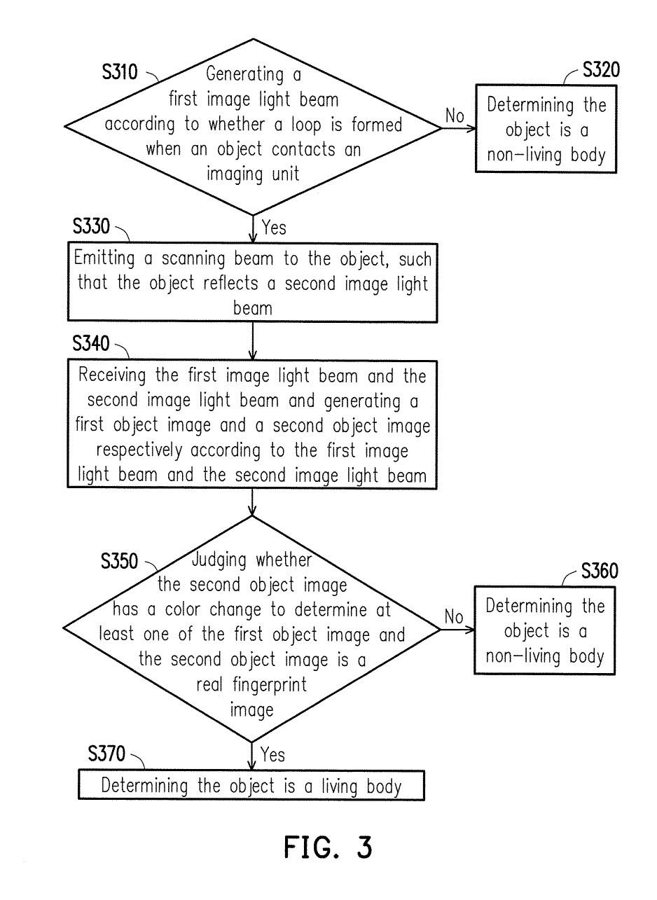

FIG. 3 is a flowchart illustrating steps of a fingerprint identification method according to an embodiment of the invention. Referring to FIG. 1 and FIG. 3, the method provided by the embodiment is at least suitable for the fingerprint identification module 100 in FIG. 1. The fingerprint identification method provided by the embodiment includes at least following steps. In step S310, the first image light beam L1 is generated by the imaging unit 110 according to whether a loop is formed when the object 1 contacts the image unit 110. If no loop is formed, in step S320, the first image light beam L1 cannot be formed by the imaging unit 110, and thus the object 1 is determined as a non-living body by the processing unit 150. If the loop is formed, in step S330, the first image light beam L1 is generated by the imaging unit 110, and a scanning beam is emitted to the object 1 by the light emitting element 130, such that the second image light beam L2 is reflected to the optical receiver 140 by the object 1. Next, in step S340, the first image light beam L1 and the second image light beam L2 are received by the optical receiver 140, and the first object image I1 and the second object image I2 are generated respectively according to the first image light beam L1 and the second image light beam L2. Next, in step S350, whether the second object image I2 has a color change is judged by the processing unit 150 to determine at least one of the first object image I1 and the second object image I2 is a real fingerprint image. If the second object image I2 has no color change, in step S360, the object 1 is determined as a non-living body, and the first object image I1 is judged as a non-real fingerprint image by the processing unit 150. If the second object image I2 has the color change, in step S370, the object 1 is determined as a living body, and at least one of the first object image I1 and the second object image I2 is judged as a real fingerprint image by the processing unit 150. As such, the processing unit 150 may further authenticate the identity through the fingerprint feature according to at least one of the first object image I1 and the second object image I2.

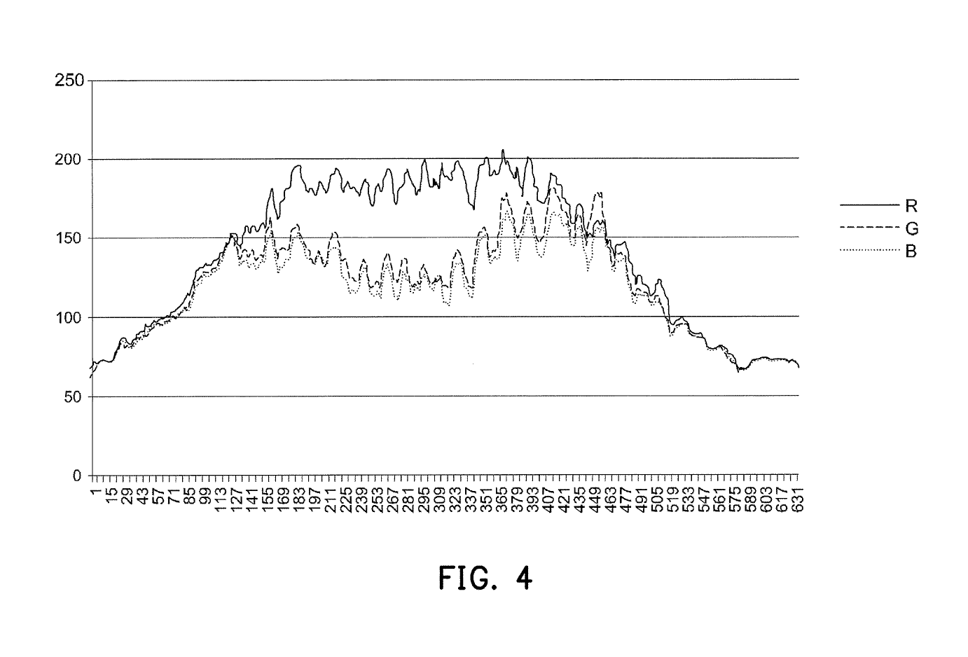

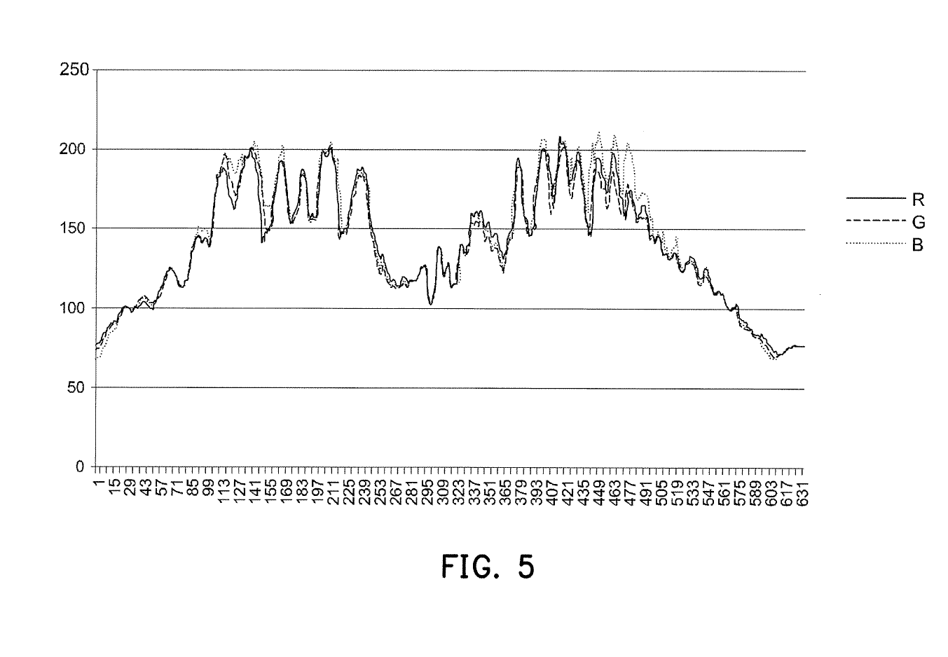

It should be noted that the color analysis refers to the following analysis operations performed by the processing unit 150 after the second object image I2 is received by the processing unit 150. FIG. 4 is a schematic view illustrating a first chromaticity coordinate axis of a real fingerprint according to an embodiment of the invention. FIG. 5 is a schematic view illustrating a first chromaticity coordinate axis of a fake fingerprint according to an embodiment of the invention. Referring to FIG. 4 and FIG. 5, a first chromaticity coordinate axis is obtained after the second object image I2 is analyzed according to a first color model by the processing unit 150. Next, a first color wavelength curve, a second color wavelength curve, and a third color wavelength curve may be obtained according to the first chromaticity coordinate axis by the processing unit 150. For example, the first color model may be a red-blue-green color model (the RBG color model); therefore, the first color wavelength curve, the second color wavelength curve, and the third color wavelength curve may respectively be a red wavelength curve, a green wavelength curve, and a blue wavelength curve. However, the invention is not limited thereto.

Specifically, when a finger is pressed on the imaging unit 110, the skin color of the finger of a living body changes, meaning that some of the blood of the finger stays at the region pressed by the finger, and the rest of the blood flows toward other parts of the body outside the pressed region from the pressed region. A skin color change is thus easily observed when the finger is pressed on the imaging unit 110. Thereby, as shown in FIG. 4 and FIG. 5, whether the first color wavelength curve overlaps the second color wavelength curve and the third color wavelength curve is judged by the processing unit 150 to determine the second object image I2 is a finger of a living body and is a real fingerprint image.

Nevertheless, the object 1 may be a fake finger made of silica gel, and fake capillaries may also be deliberately fabricated as a result. Therefore, whether a red wavelength curve in the first chromaticity coordinate axis of the second object image I2 matches a predetermined first skin color threshold may be further analyzed by the processing unit 150, so as to determine whether the red wavelength curve is evidently higher than the green wavelength curve and the blue wavelength curve, such that whether the object 1 is a finger of a living body may be effectively judged by the processing unit 150.

For example, whether the object 1 is a finger of a living body may be determined by the processing unit 150 through the following Formula (1) and Formula (2).

R−min(B,G)>Z Formula (1)

10<Z<100 Formula (2)

Here, R represents a red wavelength value, G represents a green wavelength value, B represents a blue wavelength value, and Z represents the predetermined first skin color threshold. If 10<Z<100 is satisfied, step S230 is performed. If 10<Z<100 is not satisfied, the object 1 is determined as a fake finger object. It should be noted that Formula (1) and Formula (2) are merely an exemplary embodiment, and the invention is not limited thereto. Contents and values of the formulas may be set according to actual requirements.

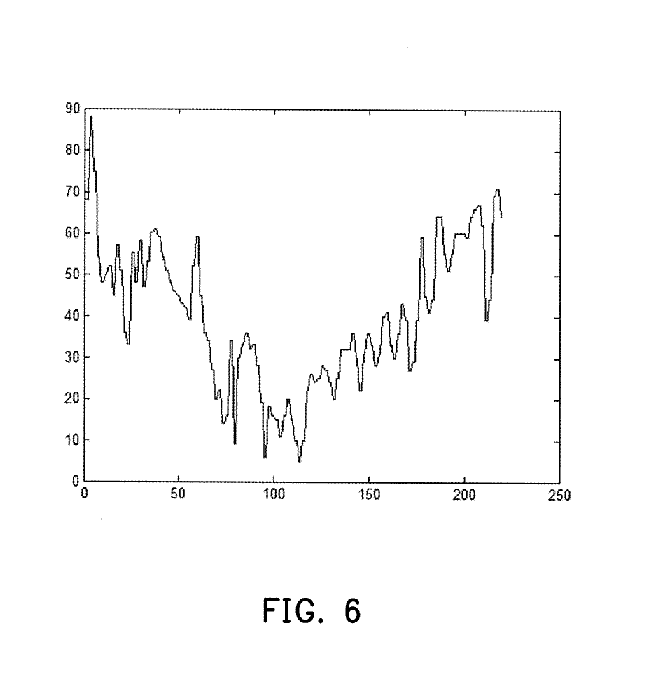

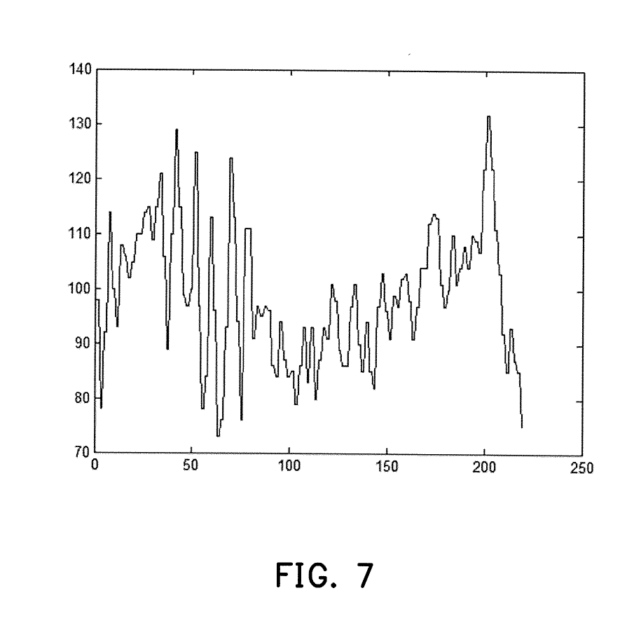

Nevertheless, the object 1 may be a fake finger made of silica gel; moreover, the red wavelength curve may be deliberately adjusted to be higher than the green wavelength curve and the blue wavelength curve. Hence, an authentication operation may be further performed by the processing unit 150. FIG. 6 is a schematic view illustrating a second chromaticity coordinate axis of a real fingerprint according to an embodiment of the invention. FIG. 7 is a schematic view illustrating a second chromaticity coordinate axis of a fake fingerprint according to an embodiment of the invention. Referring to FIG. 6 and FIG. 7, the first chromaticity coordinate axis may be converted into the second chromaticity coordinate axis by the processing unit 150 according to the second color model. The second chromaticity coordinate axis may be, for example, a CMYK color model. Fake capillaries in the fake finger may be designed according to the first color model (the red-blue-green color model), and a scenario of the red wavelength curve evidently higher than the green wavelength curve and the blue wavelength curve may also be fabricated. However, whether the second chromaticity coordinate axis of the second object image I2 matches the predetermined second skin color threshold may be judged by the processing unit 150 according to the embodiments of the invention, such that whether the object 1 is a finger of a living body is further authenticated.

For example, whether the object 1 is a finger of a living body may be determined by the processing unit 150 through the following Formula (3) and Formula (4).

Y<Z′ Formula (3)

10<Z′<100 Formula (4)

Here, Y represents a level value of yellow, and Z′ represents the predetermined second skin color threshold. If the Formula (3) and Formula (4) are satisfied, the object 1 is determined as a finger of a living body by the processing unit 150. On the contrary, if the Formula (3) and Formula (4) are not satisfied, the object 1 is determined as a fake finger. It should be noted that Formula (3) and Formula (4) are merely an exemplary embodiment, and the invention is not limited thereto. Contents and values of the formulas may be set according to actual requirements. For example, a skin color change distribution of a finger of a living body in various chromaticity coordinate axes (e.g., the CMYK chromaticity coordinate axis, the YUV chromaticity coordinate axis, the CIE XYZ chromaticity coordinate axis, the HSV chromaticity coordinate axis, etc.) may also be analyzed by the processing unit 150 through a statistical analysis method, so as to set the second skin color threshold corresponding to each of the second chromaticity coordinate axes.

It can thus be seen that although the fake capillaries in the fake finger are designed according to the first color model (the red-blue-green color model), and thereby the scenario in which the red wavelength curve is evidently higher than the green wavelength curve and the blue wavelength curve may be fabricated, whether the object 1 is a finger of a living body may be further authenticated through the predetermined second skin color threshold of the second chromaticity coordinate axis by the processing unit 150 according to the embodiment. If the converted second chromaticity coordinate axis matches the predetermined second skin color threshold, the object 1 is determined as a finger of a living body. However, if the converted second chromaticity coordinate axis does not match the predetermined second skin color threshold, the object 1 is determined as a fake finger.

In addition, the overall first object image I1 or the overall second object image I2 may be divided into a plurality of sub-images by the processing unit 150 according to the embodiments, so as to perform individual color analyses. Alternately, the overall first object image I1 or the overall second object image I2 may also be analyzed directly, and the invention is not limited thereto. Moreover, the first color model is not limited to the red-blue-green color model. The first color model may be, for example, the YUV color model, the YCbCr color model, the RAW Bayer color model, the CCIR color model, the ITU color model, or the RAW RGB color model. Besides, the second color model is not limited to the CMYK color model. The second color model may be, for example, the CMYK color model, the YUV color model, the CIE XYZ color model, or the HSV color model. Corresponding color models may be selected as the first color model and the second color model according to actual requirements. In other words, when the first chromaticity coordinate axis is converted into the second chromaticity coordinate axis, the conversion is not limited to the conversion of the RGB chromaticity coordinate axis into the CMYK chromaticity coordinate axis. The RGB chromaticity coordinate axis may be converted into the YUV chromaticity coordinate axis, the RGB chromaticity coordinate axis may be converted into the CIE XYZ chromaticity coordinate axis, or the RGB chromaticity coordinate axis may be converted into the HSV chromaticity coordinate axis according to actual requirements. Thereby, the skin color changes of different chromaticity coordinates are obtained through interactive coordinate conversions.

In view of the foregoing, the fingerprint identification module and the fingerprint identification method described in the embodiments of the invention provide that before the fingerprint identification module identifies the fingerprint feature, whether the finger is a living body is determined according to whether the loop is formed when the object contacts the imaging unit to generate the first image light beam. Next, the second object image formed by the second image light beam reflected by the object is further analyzed by the fingerprint identification module, such that whether the second object image has the color change is judged to determine once again whether the object contacting the imaging unit is a finger of a living body. As such, it can be further determined that whether at least one of the first object image and the second object image obtained by the imaging unit is a real fingerprint image. It can thus be seen that in the embodiments of the invention, a real finger or a fake finger may be identified by the fingerprint identification module and the fingerprint identification method effectively through the two-phase identification mechanism.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A fingerprint identification module comprising:
an imaging unit, configured to generate a first image light beam according to whether a loop is formed when an object contacts the imaging unit;
a light emitting element, configured to emit a scanning beam to the object, such that the object reflects a second image light beam;
an optical receiver, configured to receive the first image light beam and the second image light beam and generate a first object image and a second object image respectively according to the first image light beam and the second image light beam; and
a processing unit, electrically connected to the optical receiver and configured to receive the first object image and the second object image, wherein the processing unit judges whether the second object image has a color change to determine the object is a living body.

2. The fingerprint identification module as claimed in claim 1, wherein the imaging unit comprises:
an electrode;
a light emitting layer, disposed on the electrode;
a first dielectric layer, disposed on the light emitting layer; and
a second dielectric layer, disposed between the light emitting layer and the electrode,
wherein at least one portion of the object contacts one portion of the first dielectric layer, such that the light emitting layer emits the first image light beam corresponding to the portion of the first dielectric layer, and the optical receiver is disposed on a transmission path of the first image light beam and the second image light beam.

3. The fingerprint identification module as claimed in claim 2, further comprising:
an excitation source, electrically connected to the electrode of the imaging unit and the object and configured to output an energy to the electrode of the imaging unit and the object, wherein the energy enables the light emitting layer to emit light.

4. The fingerprint identification module as claimed in claim 3, wherein the excitation source is a power source and is electrically connected to the electrode of the imaging unit and the object.

5. The fingerprint identification module as claimed in claim 3, further comprising:
a conductive element, disposed on the first dielectric layer or integrated in the first dielectric layer and electrically connected to the excitation source, such that the object is electrically connected to the excitation source through the conductive element.

6. The fingerprint identification module as claimed in claim 1, wherein the scanning beam emitted by the light emitting element is a single-wavelength beam or a multiple-wavelength beam.

7. The fingerprint identification module as claimed in claim 1, wherein the processing unit analyzes the second object image according to a first color model to obtain a first chromaticity coordinate axis, and the processing unit obtains a first color wavelength curve, a second color wavelength curve, and a third color wavelength curve according to the first chromaticity coordinate axis,
wherein the processing unit judges whether the first color wavelength curve overlaps the second color wavelength curve or the third color wavelength curve to determine the second object image has the color change.

8. The fingerprint identification module as claimed in claim 7, wherein the first color model is a YUV color model, a YCbCr color model, a RAW Bayer color model, a CCIR color model, a ITU color model, or a RAW RGB color model.

9. The fingerprint identification module as claimed in claim 7, wherein the processing unit further judges whether the first chromaticity coordinate axis matches a predetermined first skin color threshold to determine the second object image has the color change.

10. The fingerprint identification module as claimed in claim 7, wherein the processing unit further converts the first chromaticity coordinate axis to a second chromaticity coordinate axis according to a second color model, and the processing unit judges whether the second chromaticity coordinate axis matches a predetermined second skin color threshold to determine the second object image has the color change.

11. The fingerprint identification module as claimed in claim 10, wherein the second color model is a CMYK color model, a YUV color model, a CIE XYZ color model, or a HSV color model.

12. A fingerprint identification method suitable for a fingerprint identification module, the fingerprint identification module comprising an imaging unit, a light emitting element, an optical receiver, and a processing unit, wherein the fingerprint identification method comprises:
generating a first image light beam according to whether a loop is formed when an object contacts the imaging unit;
emitting a scanning beam to the object, such that the object reflects a second image light beam;
receiving the first image light beam and the second image light beam and generating a first object image and a second object image respectively according to the first image light beam and the second image light beam; and
judging whether the second object image has a color change to determine the object is a living body.

13. The fingerprint identification method as claimed in claim 12, wherein the scanning beam emitted by the light emitting element is a single-wavelength beam or a multiple-wavelength beam.

14. The fingerprint identification method as claimed in claim 2, wherein the step of judging whether the second object has the color change to determine the object is the living body comprises:
analyzing the second object age according to a first color model to obtain a first chromaticity coordinate axis and obtaining a first color wavelength curve, a second color wavelength curve, and a third color wavelength curve according to the first chromaticity coordinate axis; and
judging whether the first color wavelength curve overlaps the second color wavelength curve or the third color wavelength curve to determine at least one of the first object image and the second object image is a real fingerprint image, so as to perform a fingerprint identification on the real fingerprint image.

15. The fingerprint identification method as claimed in claim 14, wherein the first color model is a YUV color model, a YCbCr color model, a RAW Bayer color model, a CCIR color model, a ITU color model, or a RAW RGB color model.

16. The fingerprint identification method as claimed in claim 14, wherein the step of judging whether the second object has the color change to determine the object is the living body further comprises:
judging whether the first chromaticity coordinate axis matches a predetermined first skin color threshold.

17. The fingerprint identification method as claimed in claim 14, wherein the step of judging whether the second object has the color change to determine the object is the living body further comprises:
converting the first chromaticity coordinate axis to a second chromaticity coordinate axis according to a second color model; and
judging whether the second chromaticity coordinate axis matches a predetermined second skin color threshold.

18. The fingerprint identification method as claimed in claim 17, wherein the second color model is a CMYK color model, a YUV color model, a CIE XYZ color model, or a HSV color model.
